(19) United States
(12) Patent Application Publication
(10) Pub. No.: US 2026/0301088 A1
(43) Pub. Date: Oct. 1, 2026

(54) AUTOMATING INTELLECTUAL PROPERTY SUBMISSIONS USING ARTIFICIAL INTELLIGENCE-BASED SYSTEMS AND APPLICATIONS

(71) Applicant: NVIDIA Corporation, Santa Clara, CA (US)

(72) Inventor: Ruthie D. Lyle, Durham, NC (US)

(21) Appl. No.: 19/095,707

(22) Filed: Mar. 31, 2025

(51) Int. Cl. G06Q 50/18; H04L 51/02

(52) U.S. Cl. CPC G06Q 50/184; H04L 51/02

(57) ABSTRACT

In various examples, Artificial Intelligence (AI)-based systems and methods may be used to autonomously manage intellectual property (IP)-related submissions. For example, a system(s) may obtain project-related information from one or more sources and use one or more AI models (e.g., a multimodal AI model(s)) to automatically generate a document representative of an invention submission. In some instances, the AI model(s) may identify missing details related to the invention submission and perform one or more operations to obtain those missing details. For instance, the AI model(s) may search through additional sources of information and/or initiate conversations with relevant individuals (e.g., inventors) to collect the missing information. Additionally, in some examples, the system(s) may automatically escalate certain tasks and take proactive actions, such as initiating a review or approving an invention submission responsive to learning that a public disclosure is approaching.

### BACKGROUND

Artificial Intelligence (AI)-based technologies are increasingly being used to streamline various-and oftentimes complex-workflows, thereby reducing the time and effort required for tasks that traditionally rely on manual input. For example, from automating data collection to improving decision-making, AI-based systems may help professionals or other individuals manage large volumes of information more effectively and/or efficiently. In particular, AI has been applied to structured processes that involve responding to predefined sets of questions, aggregating information from multiple sources, and refining submissions to improve accuracy and completeness. These advancements have the potential to enhance enterprise operations, allowing technical teams to focus on innovation while minimizing administrative overhead.

However, many of today's professionals are still often required to manually enter various technical, administrative, and/or any other kinds of information when completing certain tasks. For example, the process of submitting information relating to intellectual property (IP) opportunities typically involves an individual manually answering a number of specific questions related to an IP opportunity. While some teams and/or individuals may be highly engaged in such processes, others may be more focused on other projects and/or have limited time available to capture and document their innovations. Additionally, as organizations grow, the number of potential IP opportunities may increase, thereby creating a need for more intelligent and efficient solutions that can assist in capturing all of an enterprise's innovative ideas while reducing potential burdens on enterprise and/or other personnel.

### SUMMARY

Embodiments of the present disclosure relate to automating intellectual property submissions using artificial intelligence (AI)-based systems and applications. Systems and methods are disclosed that may obtain project-related information from one or more sources and use one or more AI models (e.g., a multimodal AI model(s)) to automatically generate a document representative of an invention submission (or any other type of intellectual property submission). For instance, the invention submission document may include a plurality of questions, and the systems of the present disclosure may use the AI model(s) to process the project-related information and generate responses to the plurality of questions. In some instances, the AI model(s) may identify missing details related to the invention submission and perform one or more operations to obtain those missing details. For instance, the AI model(s) may search through additional sources of information and/or initiate conversations with relevant individuals (e.g., inventors) to collect the missing information. Additionally, in some examples, the system(s) may automatically escalate certain tasks and take proactive actions to preserve intellectual property rights, such as initiating a review or approving an invention submission responsive to learning that a public disclosure is approaching.

In contrast to conventional systems, the systems of the present disclosure, in some embodiments, may streamline intellectual property-related submission processes (or any other processes) by leveraging multimodal AI. For instance, by automatically collecting and processing project-related data from diverse sources—such as meeting minutes, internal documents, and communication logs—the systems and methods of the present disclosure may reduce burdens on inventors and case managers, ensuring that patentable ideas and other intellectual property-related assets are efficiently captured across an enterprise. Additionally, in contrast to convention systems, the systems of the present disclosure may use AI-driven chatbots to facilitate iterative discussions with inventors, identifying and resolving missing details while enhancing the completeness and accuracy of invention submissions. Furthermore, by proactively escalating time-sensitive cases and initiating reviews when public disclosures may be imminent, the systems and methods of the present disclosure may help organizations protect intellectual property rights more effectively. These advancements may help improve scalability, reduce administrative overhead, and foster broader participation in intellectual property-related processes, ultimately enabling enterprises to maximize the value of their intellectual property portfolios.

### BRIEF DESCRIPTION OF THE DRAWINGS

The present systems and methods for automating intellectual property submissions using artificial intelligence-based systems and applications are described in detail below with reference to the attached drawing figures, wherein:

FIG. 1 is a data flow diagram illustrating an example of a process for generating a document(s) corresponding to an intellectual property submission(s), in accordance with some embodiments of the present disclosure;

FIG. 2 illustrates an example of an agentic AI architecture which may be used to perform one or more operations on behalf of one or more of the various components illustrated in FIG. 1, in accordance with some embodiments of the present disclosure;

FIG. 3 is a block diagram illustrating example detail associated with an AI agent, in accordance with some embodiments of the present disclosure;

FIG. 4 illustrates an example of a system that may perform one or more of the processes described herein, in accordance with some embodiments of the present disclosure;

FIG. 5 is a flow diagram illustrating an example of a method for automating intellectual property submissions using AI, in accordance with some embodiments of the present disclosure;

FIG. 6 is a flow diagram illustrating an example of a method for generating a document using different portions of information obtained from various sources, in accordance with some embodiments of the present disclosure;

FIG. 7 is a flow diagram illustrating an example of a method for obtaining additional information for generating an invention disclosure document, in accordance with some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to automating intellectual property submissions using artificial intelligence (AI)-based systems and applications. For instance, the disclosed systems and methods may, in some examples, obtain project-related information from one or more sources and use one or more AI models (e.g., a multimodal AI model(s)) to automatically generate a document representative of an invention submission (or any other kind of intellectual property submission, such as a brand/source identity (e.g., name, logo, etc.) submission for a trademark, a creative content submission for a copyright, etc.). In some examples, the invention (or innovation) submission document may include a plurality of questions, and the systems of the present disclosure may use the AI model(s) to process the project-related information and generate responses to the plurality of questions. In some instances, the AI model(s) may identify missing details related to the invention submission and perform one or more operations to obtain those missing details. For instance, the AI model(s) may search through additional sources of information and/or initiate conversations with relevant individuals (e.g., inventors) to collect the missing information. Additionally, in some examples, the systems and methods may automatically escalate certain tasks and take proactive actions to preserve intellectual property rights, such as initiating a review or approving an invention submission responsive to learning that a public disclosure is approaching.

By way of example, and not limitation, a system(s) may obtain information (e.g., project-related information) or other data from one or more sources. As described herein, the information may be related to a project (e.g., IP asset, invention, innovation, etc.) and may describe various details associated with the project, such as what the project is, how it works, how it relates to other projects, what is novel or unique about the project, individual who were involved in the project, motivations behind the project, or any other details. For instance, the source(s) the system(s) may obtain the information from may include, but are not limited to, white papers about the project, recordings from project meetings, project meeting minutes/summaries, chat logs, email data, system diagrams, internal enterprise blog posts, project management software archives, pending conference papers, or any other sources of information.

In at least some examples, the information may be user supplied (e.g., supplied or input by one or more individuals associated with the project). For instance, a user (e.g., project lead, case manager, etc.) may provide one or more of the source(s) of the information as an input to the system(s) or may direct the system(s) to which source(s) to obtain the information from.

In some instances, the system(s) may process the information using one or more AI models. For instance, the AI models may include, but are not limited to, multimodal AI models, natural language processing (NLP) models, retrieval-augmented generation (RAG) models, language models (e.g., large language models (LLMs), small language models (SLMs), multimodal language models (MMLMs), vision language models (VLMs), etc.), or any other kind of AI or machine learning models. In at least some examples, the AI model(s) may be associated with one or more AI agents, as described in further detail herein. The processing may involve extracting relevant details, identifying key technical aspects, and structuring the extracted information to align with predefined invention submission formats. The system(s) may further analyze the obtained information to determine whether it sufficiently answers one or more questions associated with an invention disclosure form (IDF). In such instances, if any gaps or inconsistencies are detected (e.g., one or more answers to one or more of the questions are unknown, etc.), the system(s) may take additional steps to acquire the missing details.

By way of example, and not limitation, the system(s) may use a chatbot interface to iteratively engage with individuals associated with the project to clarify ambiguous responses or gather additional information. The chatbot may be fine-tuned to understand technical discussions and may communicate through various channels, such as email, instant messaging applications (e.g., Slack, Microsoft Teams, etc.), or scheduled virtual meetings. In some cases, the chatbot may present specific questions derived from the IDF template, allowing individuals to respond in natural language. The system(s) may process these responses using the AI model(s) to refine and enhance the invention submission document.

Additionally, or alternatively, the system(s) may obtain additional information from other sources to determine the missing details from an invention submission. For instance, the system(s) may access various files, documents, project logs, etc. to obtain missing information. In such instances, the system(s) may examine these additional sources prior to engaging in conversations with inventors. For instance, instead of just reaching out to potential inventors when information about certain aspects of an invention submission is unknown, the system(s) may first attempt to determine the unknown information from the sources available to it (e.g., to avoid burdening potential inventors with unnecessary questions).

In at least some examples, the system(s) may use the AI model(s) to infer relevant metadata about the invention submission. For instance, the system(s) may analyze project-related documents and determine potential contributors who played a role in the development of the innovation. This determination may be based on authorship of technical documents, participation in relevant meetings, mentions in email threads, contributions in code repositories, and/or any other contributions. In some instances, the system(s) may populate the IDF with a list of potential inventors and notify these individuals for verification or confirmation of their involvement. In some examples, the system(s) may infer novel aspects of the invention and determine which individuals contributed to these novel aspects to narrow down a list of potential inventors.

As described herein, the system(s) may, in various examples, us the AI model(s) to automatically generate a draft invention submission document based on processing the information available to it. This draft may include structured responses to predefined questions in the IDF, inventor details, supporting documentation, references to relevant prior art and/or non-prior art, or any other information related to the invention. For instance, the draft invention submission document may indicate the potential novel aspects of the invention, enablement details, advantages over existing solutions, differences between the invention and existing solutions, motivation of the invention, or any other invention-related details. In at least some instances, the system(s) may identify potential prior art or non-prior art references and/or determine novel aspects of the invention by performing a similarity analysis to compare the obtained information against an internal database of previously submitted invention disclosures or patent applications.

In addition to—or in the alternative of—generating structured textual responses, the system(s) may enhance invention submission documents by incorporating visual content using one or more multimodal AI models. For instance, upon generating a text-based response to a particular question, the system(s) may analyze the response and generate a corresponding image, a sequence of images, or a video that visually illustrates the described concept. In some instances, the visual content may be generated based at least on existing images or diagrams found within the project-related information (e.g., design files, architectural diagrams, presentation slides, etc.). In such examples, the system(s) may use the provided imagery as input to generate a refined or animated visualization that clarifies the technical operation or inventive concept. In additional or alternative instances, the visual content may be generated based at least on the substance of the response(s). The resulting visual media may be embedded directly within the draft submission document or referenced via a link accessible to reviewing entities. This approach may improve the interpretability of complex responses, facilitate clearer communication of technical subject matter, and support more efficient evaluation of invention submissions.

In some examples, the system(s) may send the draft to a reviewing entity (e.g., human case manager, agentic AI system, etc.) for validation, where additional modifications or refinements may be made before formal submission and/or approval. Additionally, in some instances, the system(s) may determine/predict, monitor, and track deadlines associated with invention submissions. For instance, the system(s) may determine (e.g., based on the project-related information, based on input from users, etc.) that a public disclosure (e.g., conference presentation, blog post, research paper) of the invention is approaching and trigger an automated alert to notify relevant personnel. For instance, if a period of time between the present or current date and the predicted disclosure date is less than a threshold (e.g., a week, a month, a year, etc.), the system(s) may send an alert to the case manager or other reviewing entity. Additionally, or alternatively, if necessary, the system(s) may expedite the submission process by generating and submitting a document (e.g., a preliminary IDF, a preliminary patent application, etc.) for review, ensuring that intellectual property rights are protected before the public disclosure occurs.

In various examples, the systems and methods of the present disclosure may be implemented within an enterprise cloud environment or deployed on-premises within an organization's secure infrastructure. In such instances, security and privacy measures may be incorporated to ensure compliance with internal policies and regulations governing confidential data handling. For instance, encryption, access controls, audit logging, or any other techniques may be used to maintain the integrity and confidentiality of invention submission data. Additionally, the system(s) may support integration with external databases, intellectual property management platforms (e.g., Anaqua), or enterprise knowledge management systems. This integration may allow for seamless synchronization of intellectual property submissions with ongoing prosecution efforts, reducing administrative burden and improving efficiency in managing intellectual property portfolios.

While many of the examples herein are described in the context of an invention or innovation submission related to a patent application, this is not intended to be limiting. For instance, as described above and herein, the systems and methods of the present disclosure are broadly applicable to any type of intellectual property-related submissions and/or any type of automatic document generation/submission. For instance, the systems and methods of the present disclosure may be used to automatically “fill in the blanks” or otherwise complete a list of predefined questions by obtaining and analyzing relevant information to determine responses to these questions, which may range in complexity from simple answers (e.g., yes/no answers, 1-sentence explanations, etc.) to complex responses (e.g., multi-sentence responses, multi-paragraph responses, visual explanations, etc.).

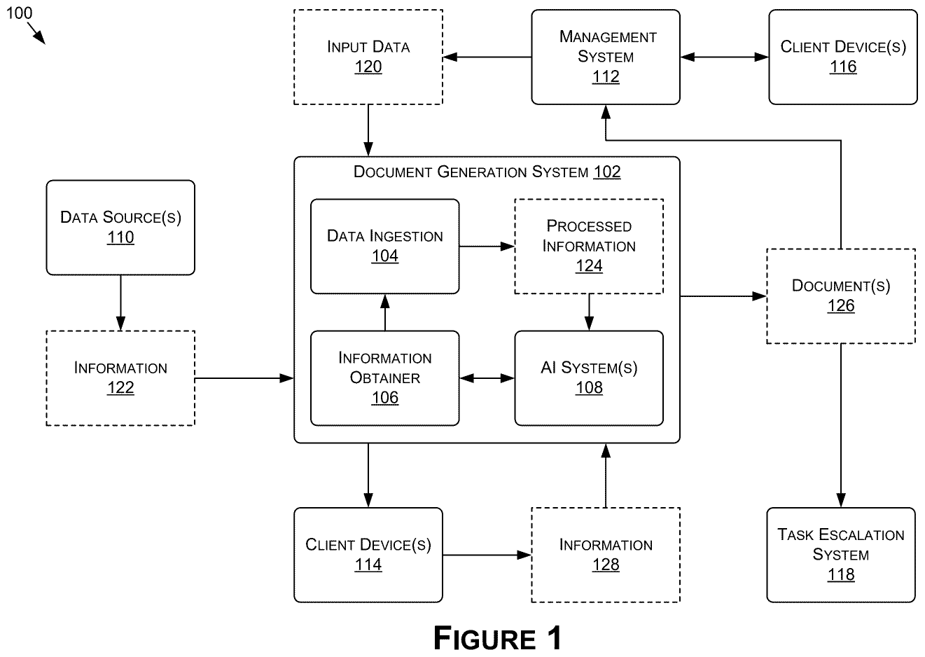

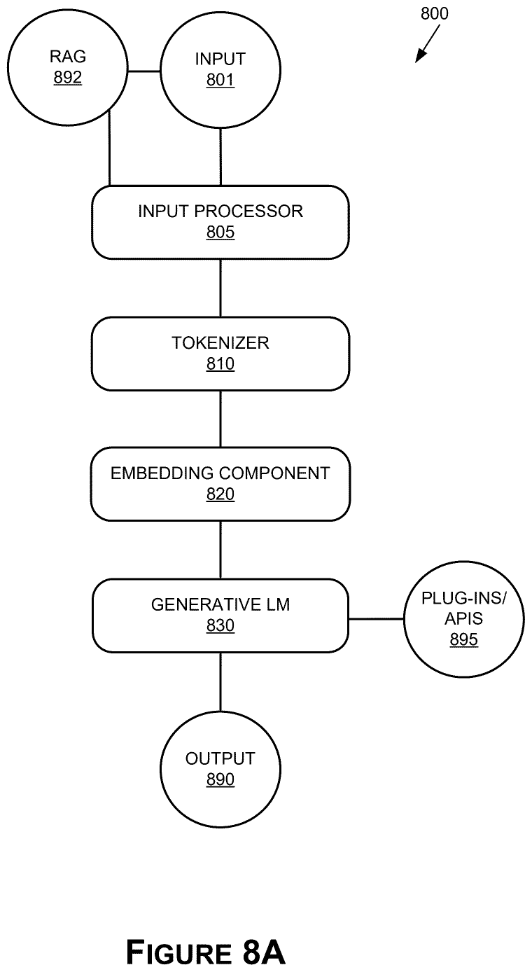

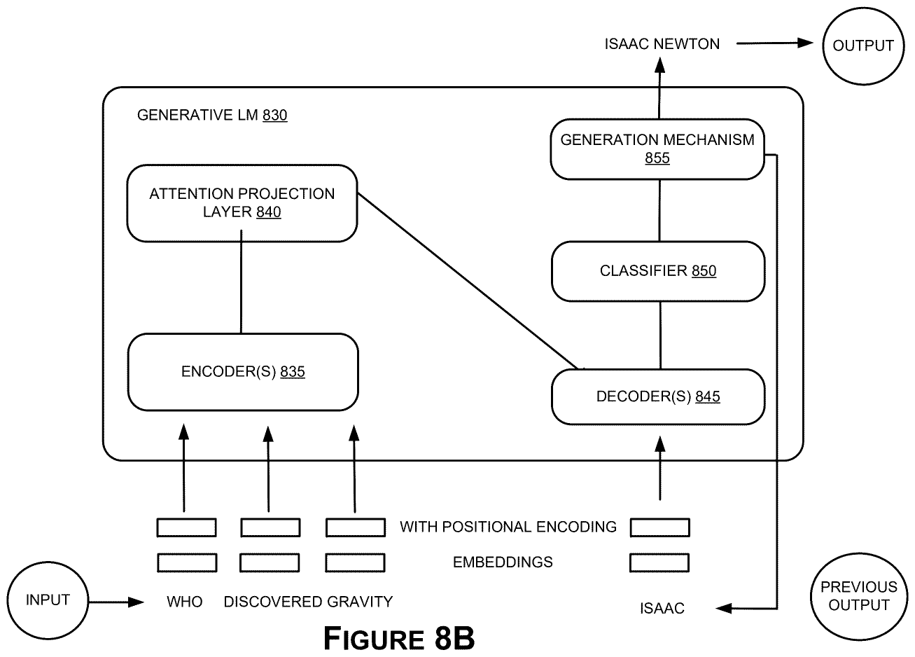

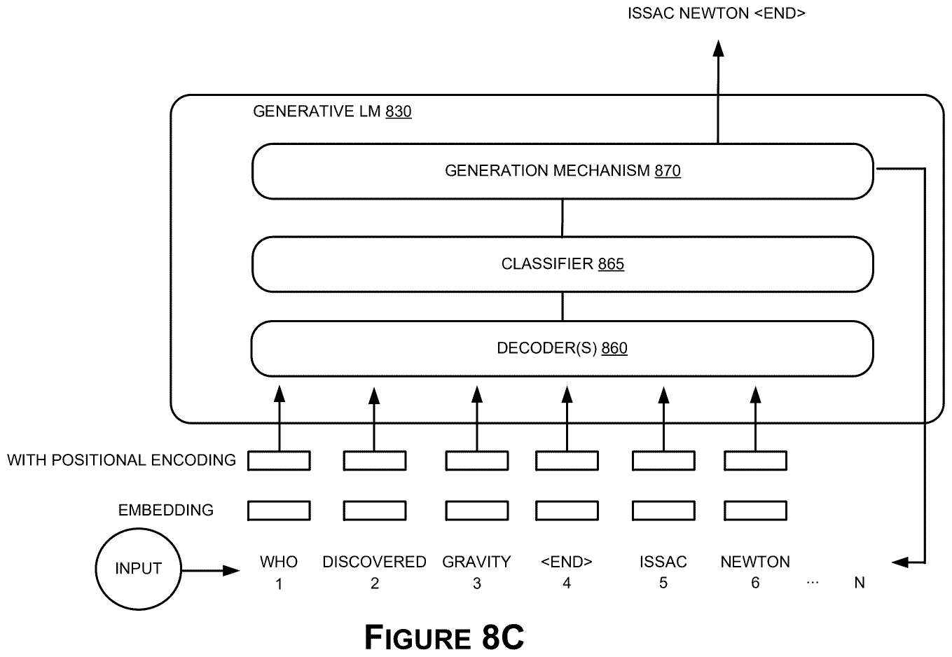

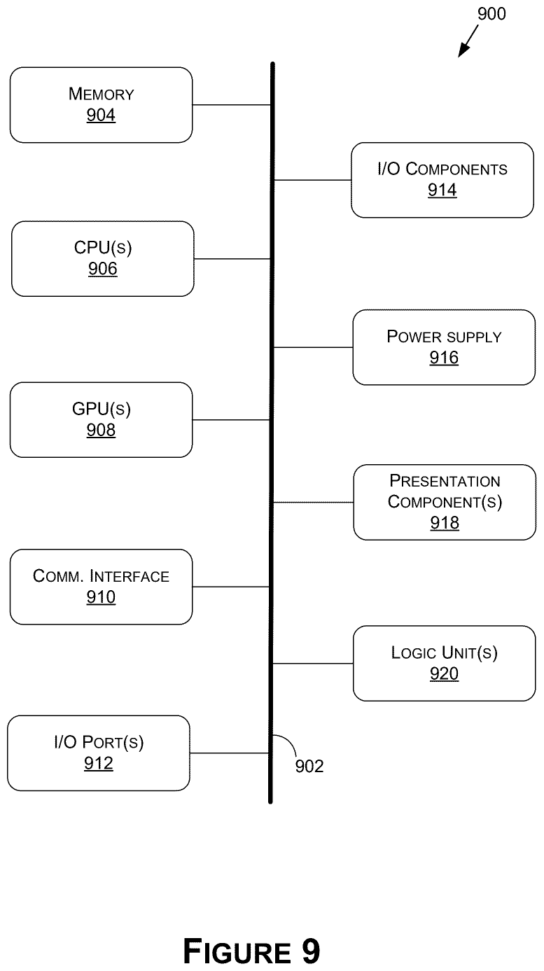

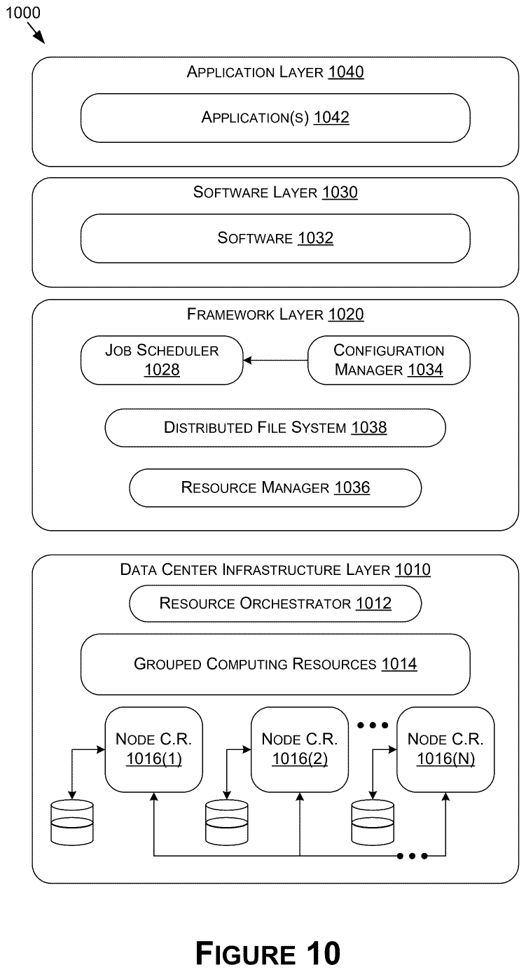

With reference to FIG. 1, FIG. 1 is a data flow diagram illustrating an example of a process 100 for generating a document(s) corresponding to an intellectual property submission(s), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

As shown in the example of FIG. 1, the process 100 may be implemented using, amongst additional or alternative components, a document generation system 102, which may include a data ingestion component 104, an information obtainer 106, and one or more AI systems 108, one or more data sources 110, a management system 112, one or more client device 114 and/or 116, and a task escalation system 118. As a brief overview of the process 100, the document generation system 102 may receive input data 120, which may represent one or more questions (e.g., one or more predefined questions included in an invention submission form). The information obtainer 106 may obtain information 122 (e.g., invention-related information) from the data source(s) 110. The document generation system 102 may use the data ingestion component 104 to process the information 122 and generate processed information 124, which may be fed into the AI system(s) 108 along with the input data 120. The document generation system 102 may use the AI system(s) 108 to generate one or more documents 126. In some examples, the AI system(s) 108 may determine that the information 122 is insufficient to generate a complete version(s) of the document(s) 126, and invoke the information obtainer 106 to communicate with the client device(s) 114 to obtain the information 128 (e.g., additional or supplemental information) so that the complete version(s) of the document(s) 126 may be generated. The document(s) 126 may be sent to the management system 112 and the client device(s) 116 may review, augment, approve, etc. the document(s) 126. Additionally, in some instances, the document(s) 126 may be provided to the task escalation system 118 (e.g., responsive to a user of the client device(s) 116 approving the document(s) 126, responsive to a determination of a public disclosure, etc.) which may perform one or more operations to cause the document(s) 126 to be converted into a draft of a patent application (or other intellectual property submission).

In some examples, the input data 120 may represent one or more questions related to an invention submission. For instance, the input data 120 may include text data representing predefined questions included in an invention submission form, a Portable Document Format (PDF) of the invention submission form itself, or any other kind of data representing one or more input prompts for the AI system(s) 108. In some examples, the input data 120 may further include indications of the data source(s) 110 that the document generation system 102 should analyze to obtain the information 122 from. For instance, the input data 120 may indicate a citation of a paper to obtain invention-related information from, a file location(s) to obtain the invention-related information from, identity(ies) of individual(s) associated with the invention, or any other information so that the document generation system 102 (and/or the information obtainer 106) may determine where to look for the invention-related information to answer the questions in the input data 120. Additionally, in some examples, the input data 120 may include some or all of the invention-related information.

In some instances, the input data 120 may be obtained from the management system 112, input directly by an individual, or obtained from any other source. For example, a case manager or an inventor using the client device(s) 116 may initiate a request to make an invention submission, causing the management system 112 to send the input data 120 to the document generation system 102. The input data 120 may specify predefined invention disclosure questions and may also reference external documents or multimedia files that contain relevant technical details. The document generation system 102 (e.g., the information obtainer 106) may use the information included in the input data extract relevant information by accessing enterprise repositories that store project documentation, system design diagrams, or previous invention submissions that may relate to the current disclosure. In some examples, receiving the input data 120 may trigger the document generation system 102 to engage in an iterative process to generate the complete version(s) of the document(s) 126.

As described herein, the information obtainer 106 of the document generation system 102 may obtain the information 122 from the data source(s) 110. In some examples, the information obtainer 106 may obtain the information 122 based at least on the input data 120. For instance, the input data 120 may include an indication(s) of the data source(s) 110 to obtain the information 122 from. For instance, if the input data 120 includes references to project documentation, the information obtainer 106 may retrieve technical design documents, white papers, pending conference papers, or any other information from an internal knowledge management system. In some examples, the data source(s) 110 may include, but are not limited to, project documentation, white papers, internal technical reports, system design diagrams, project management records, pending conference papers, internal blog posts, invention-related email exchanges, meeting transcripts, audio/video recordings from invention-related discussions, code repositories (e.g., GitHub, internal version control systems), task management systems (e.g., Jira, Asana) that contain records of project milestones and contributions by team members, and/or any other sources of information. In some examples, the information 122 may include text data from these data source(s) 110 (e.g., the text from a white paper, the text representing code from a repository, etc.), image data form the data source(s) 110 (e.g., diagrams or images included in a technical document, etc.), audio data from the data source(s) 110 (e.g., an audio recording of an invention-related meeting, etc.), or any other kind of data.

In some examples, and as described in further detail below, the information obtainer 106 may obtain additional or supplemental information (e.g., the information 128) when one or more portions of the document(s) 126 are incomplete. That is, if the document generation system 102 is unable to respond to one or more of the questions in the input data 120, the information obtainer 106 may obtain additional or supplemental information on behalf of the system so that the response(s) to the question(s) in the input data 120 may be generated. For instance, assume that a question in the input data 120 asks for the residency and citizenship of each inventor, and that this information is not included in the information 122, then the information obtainer 106 may communicate with the client device(s) 114 and/or access intellectual property management platforms (e.g., Anaqua) and/or enterprise knowledge management systems to obtain the information 128 about the citizenship and residency of each inventor.

The process 100 may also include the document generation system 102 using the data ingestion component 104 to process the information 122 (and/or the information 128) and generate processed information 124, which may be fed into the AI system(s) 108. In some examples, the data ingestion component 104 may use or leverage multimodal AI techniques to extract, classify, and structure data from various sources, such as text documents, audio/video recordings, code repositories, and/or project management systems. For instance, if the information 122 includes audio or video recordings of project discussions, the data ingestion component 104 may use speech-to-text transcription models (e.g., NVIDIA's NeMo, Google Cloud Speech-to-Text, etc.) to convert spoken content into textual data for further analysis. Similarly, if the information 122 includes technical diagrams or system architecture schematics, the data ingestion component 104 may employ computer vision models to interpret and categorize visual data. Furthermore, in some embodiments, the data ingestion component 104 may parse unstructured text from meeting notes, email correspondences, or Slack conversations using natural language processing (NLP) techniques (e.g., spaCy, Stanford CoreNLP, etc.) to extract relevant invention-related details.

In various examples described herein, the document generation system 102 may use the AI system(s) 108 to generate the document(s) 126. In some examples, the AI system(s) 108 may include any type(s) of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multi-modal language models (MMLMs), and/or other types of machine learning models.

In some examples, the machine learning model(s) of the AI system(s) 108 may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The model(s) (e.g., the model(s) of the AI system(s) 108, etc.) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

In some examples, the AI system(s) 108 may include or represent an agentic AI architecture that includes one or more AI agents (e.g., LLM agents). The various AI agents of the agentic architecture may each be configured to perform various specialized tasks associated with generating the document(s) 126. In some instances, the AI agents may perform one or more functionalities of the various components shown in FIG. 1, such as the information obtainer 106, the task escalation system 118, or any other components describe herein. In other words, one or more functions of the systems may be carried out using one or more AI agents of the agentic AI architecture.

For instance, a first agent may extract key invention-related information from project documentation, meeting transcripts, code repositories, etc., while a second agent may focus on analyzing prior art by querying internal patent databases or external sources (e.g., USPTO, EPO, etc.). Additionally, a third agent may engage in follow-up conversations with inventors, requesting more context on an invention's novelty, technical implementation, and/or potential use cases. In some cases, if conflicting or outdated information is detected across multiple sources, a fourth agent may be tasked with verifying the most recent and relevant version by comparing document timestamps or seeking human confirmation. Further, a fifth agent may monitor ongoing project developments in real time, continuously scanning for new contributions, changes in technical documentation, or planned public disclosures that could impact the invention submission. This fifth agent may automatically update the submission form or notify stakeholders (e.g., case managers, legal teams) when significant changes occur. In some examples, the agentic AI architecture may also include an AI agent dedicated to formatting and structuring the final invention submission document according to predefined templates, ensuring compliance with the requirements of the management system 112. This agent may refine and validate the information before submitting the document(s) 126 for final review or approval.

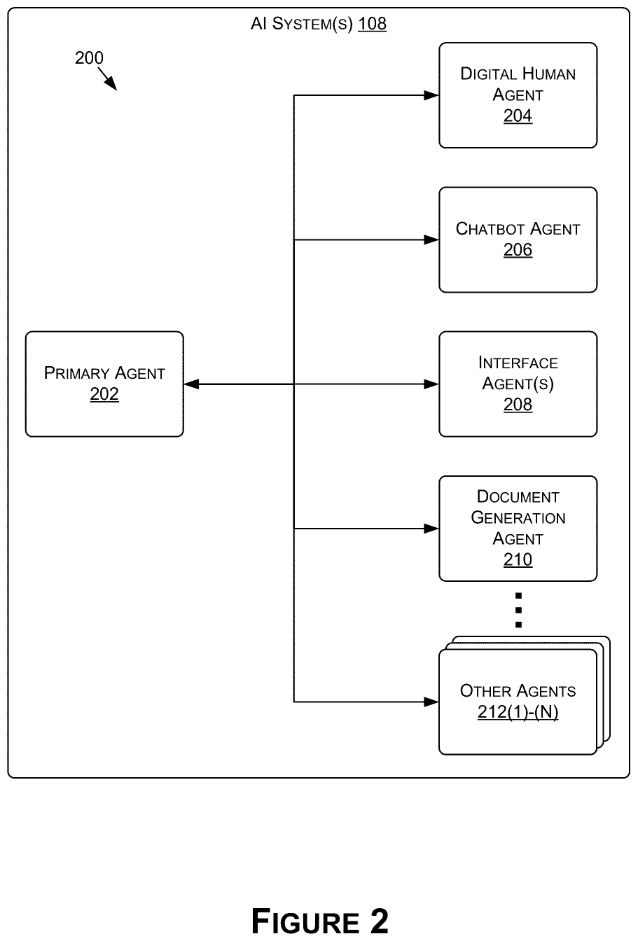

As an example, FIG. 2 illustrates an example in which the AI system(s) 108 includes an agentic AI architecture 200 which may be used to perform one or more operations on behalf of one or more of the various components illustrated in FIG. 1, in accordance with some embodiments of the present disclosure. As shown, the agentic AI architecture 200 may include a primary agent 202, a digital human agent 204, a chatbot agent 206, one or more interface agents 208, a document generation agent 210, and one or more other agents 212(1)-(N) (where “N” may represent any number of the other agents 212).

In some examples, the primary agent 202 (also referred to in some instances as a “planner agent”) may coordinate the execution of tasks among the various AI agents, determine which agent(s) should be invoked for specific operations, and manage the flow of information between different system components. For instance, the primary agent 202 may analyze the input data 120 to determine whether invention-related details need to be extracted, validated, or supplemented before generating a finalized submission. The digital human agent 204, in some examples, may simulate a virtual human presence in interactive discussions with inventors or other stakeholders. This agent may engage in real-time virtual meetings, acting as a conversational interface to gather invention-related details, ask follow-up questions, and/or guide users through the submission process. The digital human agent 204 may also assist in resolving ambiguities by requesting clarification or additional data when conflicting information is detected, in some instances.

The chatbot agent 206 may, in some instances, serve as an interactive text-based assistant and engage with users via messaging platforms such as Slack or email to, among other things, iteratively collect missing information, validate responses, and/or ensure completeness of the invention submission form. The chatbot agent 206 may proactively reach out to inventors to remind them to provide necessary details, verify contributor identities, request additional technical descriptions, and/or for any other reasons. In some examples, the interface agent(s) 208 may facilitate communication between the AI system(s) 108 and external systems, such as project management tools (e.g., Jira, Asana), version control platforms (e.g., GitHub), human resource systems (e.g., Workday), case management databases (e.g., Anaqua), and/or any other external systems. The interface agent(s) 208 may be used to interface with these external systems on behalf of the AI system(s) 108 in order to, in some examples, retrieve relevant project documentation, check for public disclosure timelines, and ensure that the AI system(s) 108 has access to the latest technical records.

The document generation agent 210, in some instances, may be able to process extracted and refined information to automatically generate a structured invention submission form (e.g., the document(s) 126). The document generation agent 210 may ensure that the document(s) 126 adheres to predefined formatting standards, properly integrates responses to invention-related questions, and aligns with enterprise requirements. Additionally, the document generation agent 210 may validate the submission for completeness and accuracy before it is finalized for review or automatic submission. The other agents 212, in some examples may include any number of additional agents for performing various specialized tasks in accordance with the present disclosure, such as task escalation agents, monitoring agents (e.g., for monitoring the progress of an invention record), agents for determining invention novelties, agents for determining whether an invention submission satisfies a threshold (e.g., includes enough inventive detail, enablement, etc.), inventor identification agents (e.g., for determining inventorship), or any other kinds of agents for performing any other kinds of tasks.

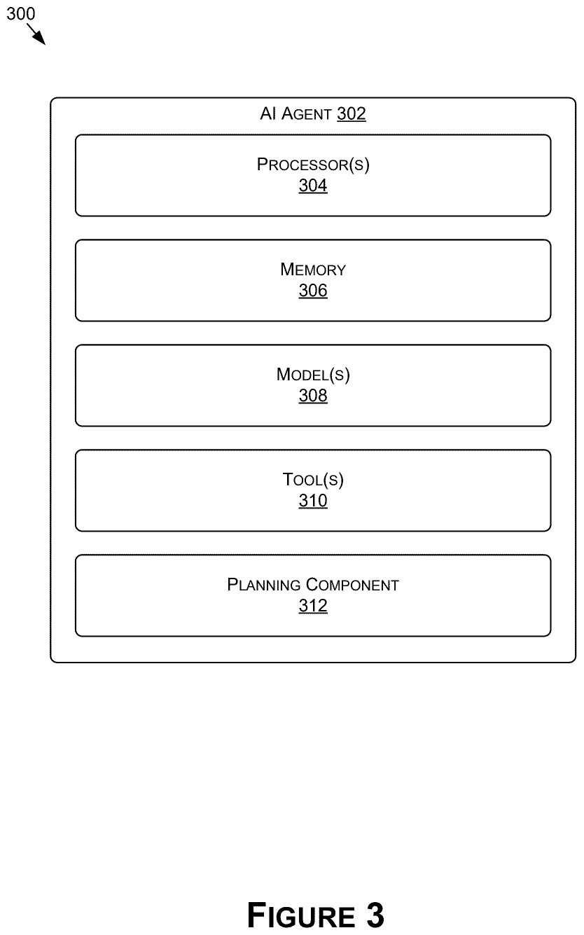

In some examples, one or more of the AI agents (e.g., each agent) may include various components and infrastructure that enable the AI agent(s) to perform their specialized tasks. For instance, FIG. 3 is a block diagram illustrating example detail 300 associated with an AI agent 302, in accordance with some embodiments of the present disclosure. As shown, the AI agent 302 (which may correspond to any one of the AI agents of the AI system(s) 108) may include one or more processors 304 (which may correspond to any of the processor(s) described herein), memory 306, one or more models 308 (e.g., language models, etc.), one or more tools 310, and a planning component 312.

Although shown as separate from the memory 306, in some examples, the memory 306 may store one or more of the model(s) 308, the tool(s) 310, and/or the planning component 312. In some instances, the memory 306 may serve as a repository for the internal records of the AI agent 302 and/or the agent's interactions with users and/or other agents. The memory may include short-term memory and/or long-term memory. In some examples, the short-term memory may act as a ledger of the actions and thoughts the AI agent 302 processes while addressing a specific query, essentially capturing the agent's “train of thought.” In contrast, the long-term memory may function as a logbook that documents ongoing interactions and events between the AI agent 302 and other agents and/or users, encompassing conversation histories that can extend over weeks or months.

As described herein, the model(s) 308 may include one or more language models (e.g., MMLMs, LLMs, SLMs, VLMs, etc.) that serve as the core engine for understanding and generating human-like text. The model(s) 308 may process inputs by analyzing the context and intent behind queries, drawing on extensive training on diverse text data to produce coherent and contextually relevant responses. By leveraging advanced algorithms, such as those found in Transformer architectures, the model(s) 308 may capture nuanced meanings and relationships between words, allowing it to handle complex language tasks like conversation, summarization, and translation. Essentially, the model(s) 308 may enable the AI agent 302 to engage in meaningful interactions, adapt to different contexts, and provide informative answers, all while continuously learning from its interactions to enhance future performance. While many of the examples described herein are with respect to using language models, and specifically, LLMs and MMLMs, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), small language models (SLMs), vision language models (VLMs), multi-modal language models (MMLMs), etc.), and/or other types of machine learning models.

The tool(s) 310 may represent or include defined, executable workflows that enable the AI agent 302 to perform various tasks efficiently. These tool(s) 310 may include, in some instances, specialized third-party APIs designed to enhance the capabilities of the AI agent 302. For example, the tool(s) 310 of the AI agent 302 may include a Retrieval-Augmented Generation (RAG) pipeline to provide context-aware responses, or a code interpreter to tackle intricate programming challenges. Additionally, the AI agent 302 may use the tool(s) 310 to access external APIs to search for information online, retrieve real-time data from services such as weather APIs, or interact with instant messaging platforms. By leveraging its tool(s) 310, the AI agent 302 may expand its functionality, enabling the AI agent 302 to handle a wide range of inquiries and tasks with greater accuracy and relevance.

The planning component 312 of the AI agent 302 may be used to address complex issues and queries. To handle such complexity, the planning component 312 may use various different strategies, such as task and question decomposition, reflection, critique, and/or other methods. For instance, when faced with a compound and/or complex question, the planning component 312 may break the question down into simpler parts. As such, the primary agent 202 may break an original query into one or more subqueries to be submitted to the other agents, and the other agents may further break these subqueries down even further. Additionally, the planning component 312 may employ reflection techniques—like ReAct, Reflexion, Chain of Thought, and/or Graph of Thought—to improve reasoning skills and refine the response process. By using these methods, the planning component 312 may enable the AI agent 302 to effectively tackle intricate queries and provide meaningful, well-informed answers.

Referring back to the example of FIG. 1, the process 100 may include the AI system(s) 108 determining that the information 122 is insufficient for generating the complete version(s) of the document(s) 126. For instance, the AI system(s) 108 may process the input data 120 and the processed information 124 corresponding to the information 122 and determine that additional information is needed. As an example, the AI system(s) 108 may determine that the novelty of the invention is unclear (e.g., after comparing the invention-related information to previous submissions or patents) and invoke the information obtainer 106 (or an AI agent with similar functionality) to obtain additional information (e.g., the information 128).

In some examples, such as when information is unknown, the AI system(s) 108 may use various techniques to determine the information or otherwise fill gaps (e.g., before invoking the information obtainer 106). For instance, the AI system(s) 108 may use retrieval-augmented generation (RAG) techniques to infer missing details or supplement information by dynamically querying internal databases, invention submission archives, or even external intellectual property repositories, such as patent databases. For instance, if the input data 120 includes references to project documentation, the AI system(s) 108 may retrieve technical design documents, white papers, pending conference papers, etc. in order to fill gaps and supplement missing information. Similarly, the AI system(s) 108 may infer potential inventors by analyzing team collaboration records, including code commit histories, task management logs, and/or recorded discussions from virtual meetings.

In some instances, such as if the AI system(s) 108 is unable to gap-fill or problem solve on its own, the AI system(s) 108 and/or the information obtainer 106 may interact with human inventors or other personnel to resolve ambiguities, clarify missing details, or confirm inferred information. As shown, the document generation system 102 may communicate with the client device(s) 114 to receive the information 128. For instance, if certain invention-related fields remain incomplete, the information obtainer 106 and/or the AI system(s) 108 may automatically reach out to identified contributors through digital communication channels (e.g., Slack, email, scheduled virtual meetings, etc.) to obtain further input. As one example, if an invention disclosure form requires information about public disclosures, the AI system(s) 108 may check internal project tracking tools for upcoming conference presentations or technical blog posts related to the invention. If any discrepancies arise—such as conflicting versions of project documentation—the AI system(s) 108 may either select the most recent version or initiate communications with a human user to validate the information.

In some examples, the process 100 may include the document generation system 102 generating and/or outputting the document(s) 126, which may represent the completed invention submission form. In some instances, the document generation system 102 may generate the document(s) 126 by using the AI system(s) 108 to process the input data 120 and some or all of the invention-related information available to it (e.g., the information 122, the processed information 124, the information 128, etc.). For instance, based on this processing, the AI system(s) 108 may generate, at least, text data representing one or more responses to the question(s) included in the input data 120. In some examples, the AI system(s) 108 may format the document(s) 126 according to predefined templates that align with management system requirements. This may include structuring responses into designated fields, ensuring compliance with patent disclosure standards, and/or automatically including metadata such as contributor (e.g., inventor) identities, project references, and related prior invention submissions.

Furthermore, in some embodiments, the AI system(s) 108 may analyze the document(s) 126 to identify potential links to existing patent families or related intellectual property records (e.g., maintained by the management system 112). If a connection is detected, the AI system(s) 108 may flag the invention submission for potential consolidation with an existing filing or suggest relevant prior disclosures for consideration. That is, the AI system(s) 108 may include in the document(s) 126 an indication(s) of the related matters.

In some examples, the AI system(s) 108 may enhance the document(s) 126 by incorporating visual content using one or more multimodal AI models. For instance, upon generating a text-based response to a particular question, the AI system(s) 108 may analyze the response and generate a corresponding image, a sequence of images, or a video that visually illustrates the described concept. In some instances, the visual content may be generated based at least on existing images or diagrams found within the project-related information 122 (e.g., design files, architectural diagrams, presentation slides, etc.). In such examples, the AI system(s) 108 may use the provided imagery as input to generate a refined or animated visualization that clarifies the technical operation or inventive concept. In additional or alternative instances, the visual content may be generated based at least on the substance of the document(s) 126. The resulting visual media may be embedded directly within the document(s) 126 and/or referenced via a link accessible to reviewing entities.

As shown, in some instances the document(s) 126 may be sent to the management system 112. The management system 112 may store and maintain one or more records associated with the invention submission document(s) 126. Additionally, in some examples, the client device(s) 116 may access the document(s) 126 through the management system 112 review, augment, approve, and/or perform any other operations associated with the invention submission document(s) 126. In some instances, the management system 112 may facilitate collaboration between inventors, case managers, and legal teams by providing access to the document(s) 126 in a centralized repository. For example, case managers may review the document(s) 126 to ensure completeness and correctness, augmenting responses where necessary before submission. If additional details are required, the management system 112 may trigger an automated feedback loop in which the AI system(s) 108, via a chatbot agent or email notifications, engages with the relevant inventors or technical contributors to obtain missing information.

Additionally, the management system 112 may cross-reference the document(s) 126 with previously submitted invention disclosures or existing intellectual property records to identify potential duplicate submissions, related patent families, or prior art references. If a connection is detected, the management system 112 may recommend linking the new invention submission to an existing record or suggest modifications to enhance its patentability.

In some examples, the management system 112 may also monitor external factors, such as upcoming public disclosures, to determine whether expedited processing is necessary. If a related conference paper, blog post, or technical presentation is detected in an internal project tracking system, the management system 112 may issue an alert to case managers (e.g., the client device(s) 116) and recommend accelerated filing of the invention submission to protect intellectual property rights. Additionally, or alternatively, the document(s) 126 may be provided to the task escalation system 118 (e.g., responsive to a user of the client device(s) 116 approving the document(s) 126, responsive to a determination of a public disclosure, etc.) which may perform one or more operations to advance the invention submission (e.g., cause the document(s) 126 to be converted into a draft of a patent application or other intellectual property submission).

Additionally, in some implementations, the document generation system 102 may autonomously monitor relevant data sources over time to ensure that the invention submission document(s) 126 remains up to date. If a new public disclosure event is detected or if additional technical developments occur after the initial submission, the document generation system 102 may update the invention record accordingly and notify relevant stakeholders. For instance, if an inventor initially states that no public disclosure is planned but later uploads an abstract to an internal conference submission system, the document generation system 102 may automatically flag the change, update the submission form, and alert the appropriate legal teams to take necessary action.

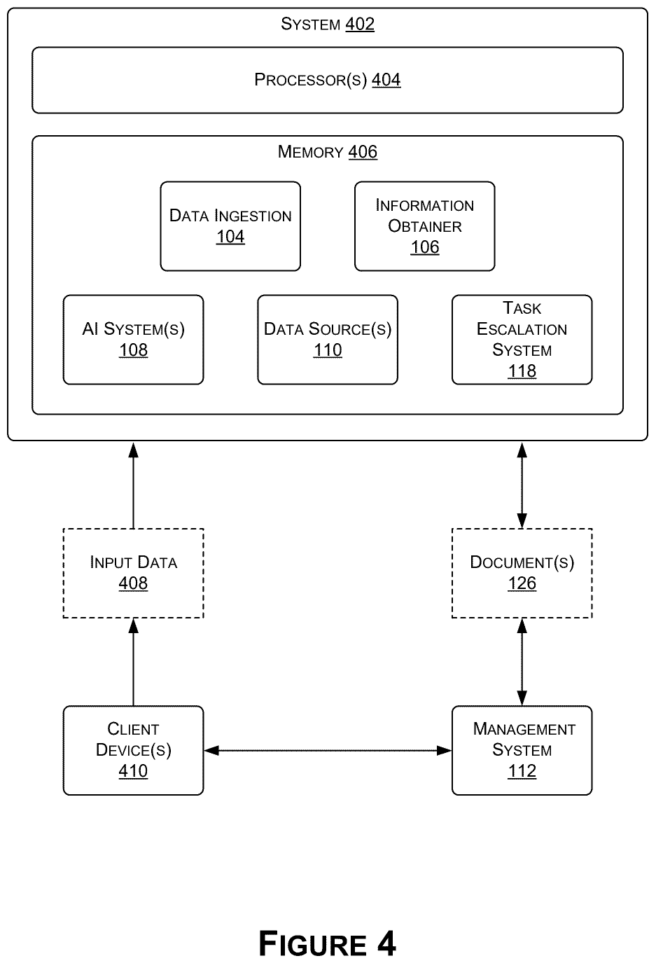

FIG. 4 illustrates an example of a system 402 that may perform one or more of the processes described herein, in accordance with some embodiments of the present disclosure. As shown, the system 402 (which may represent, and/or include, an example computing device(s) 900 and/or an example data center 1000) may include one or more processors 404 (which may be similar to, and/or include, one or more central processing units 906 and/or one or more graphics processing units 908) and memory 406 (which may be similar to, and/or include, a memory 904). For instance, the memory 406 may store one or more of the data ingestion component 104, the information obtainer 106, the AI system(s) 108, the data source(s) 110, and/or the task escalation system 118. Additionally, the processor(s) 404 may execute one or more of the data ingestion component 104, the information obtainer 106, the AI system(s) 108, the data source(s) 110, and/or the task escalation system 118 to perform one or more of the processes described herein.

For instance, the system 402 may receive input data 408 from the client device(s) 410 (which may correspond to the client device(s) 114 and/or 116). The input data 408 may include a set of questions (e.g., from an invention submission form) and various project-related information associated with an invention or innovation. The system 402 may use the AI system(s) 108 to process the input data 408 and automatically generate the document(s) 126, which may represent a completed version of the invention submission form. In some examples, the system 402 may use the information obtainer 106 to obtain additional or supplemental information related to the invention submission, such as if the AI system(s) 108 is unable to determine an answer to one or more of the questions in the input data 408. The system 402 may send the document(s) 126 to the management system 112, and the client device(s) 410 may access the document(s) 126 via the management system 112 to review, augment, approve, or perform any other operations related to the document(s) 126.

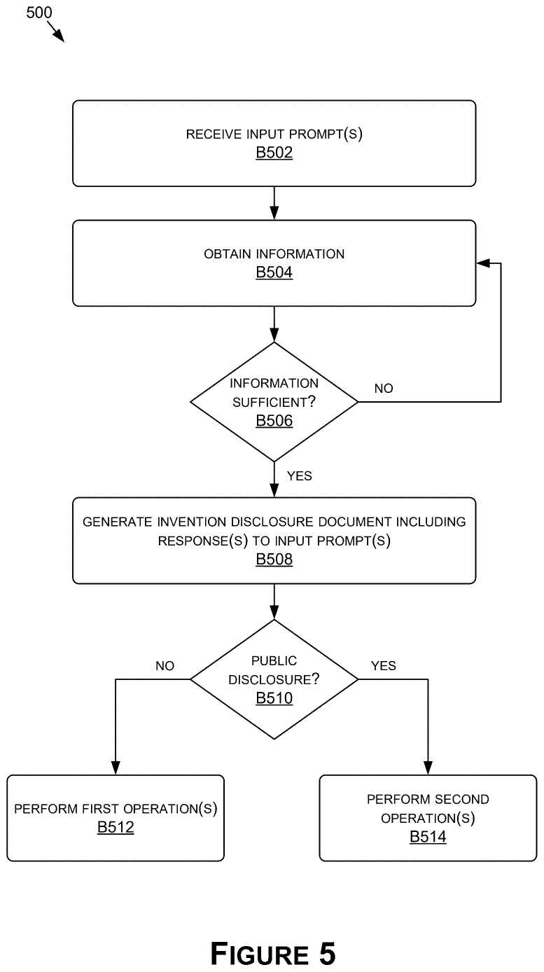

Now referring to FIGS. 5-7, each block of methods 500, 600, and 700, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 500, 600, and 700 are described, by way of example, with respect to the system of FIG. 1. However, these methods may additionally or alternatively be executed by any one system, or any combination of systems, including, but not limited to, those described herein.

FIG. 5 is a flow diagram illustrating an example of a method 500 for automating intellectual property submissions using AI, in accordance with some embodiments of the present disclosure. The method 500, at block B502, includes receiving one or more input prompts. For instance, the document generation system 102 may receive the input data 120 containing the input prompt(s) form the management system 112 and/or the client device(s). In some examples, the input prompt(s) may include a predefined question(s) from an invention submission form, such as problem statements, technical descriptions, and/or details regarding known prior art. The prompt(s) may be received from a client device associated with an inventor, a case manager, or an automated system, such as the management system 112 (e.g., Anaqua). In some cases, the prompt(s) may also include metadata specifying relevant data sources, such as project repositories, meeting transcripts, or code documentation, to guide the system in retrieving relevant information.

The method 500, at block B504, includes obtaining information. For instance, the information obtainer 106 may obtain the information 122 from the data source(s) 110. In some examples, the system may retrieve invention-related data from multiple sources, including internal documentation, project management systems (e.g., Jira), version control repositories (e.g., GitHub), and meeting transcripts. The data ingestion component 104 may employ various multimodal data extraction techniques (e.g., using the AI system(s) 108), such as speech-to-text transcription for recorded meetings, natural language processing (NLP) for analyzing technical documents, and metadata analysis for identifying contributors.

The method 500, at block B506, includes determining whether the information obtained is sufficient for responding to the input prompt(s). For instance, the AI system(s) 108 may determine whether the information obtained is sufficient for responding to the input prompt(s) and generating the completed version of the document(s) 126. In some examples, to determine whether the information obtained is sufficient for responding to the input prompt(s), the AI system(s) 108 may analyze the retrieved information to assess completeness, accuracy, and relevance to the prompt(s).

At block B506, if the information is sufficient, the method 500 may proceed to block B508. If the information is insufficient, the method 500 may proceed back to block B104 and additional information may be obtained (e.g., the information 128 may be obtained from the client device(s) 114 by engaging in an iterative discussion with inventors). For instance, if certain required details are missing, ambiguous, or conflicting, the system(s) may initiate an iterative refinement process, reaching out to inventors via chatbot agents or email prompts for further clarification. Additionally, the system(s) may cross-reference multiple data sources to resolve discrepancies or seek supplementary information from relevant stakeholders.

The method 500, at block B508, includes generating an invention disclosure document including one or more responses to the input prompt(s). For instance, the AI system(s) 108 may generate the document(s) 126 based on processing the input data 120 and the information 122 and/or 128. In some examples, once the AI system(s) 108 have gathered and validated the necessary data, the AI system(s) 108 may compile the responses into a structured invention disclosure form. The document(s) may be formatted according to predefined templates and structured into relevant fields, such as technical details, novelty aspects, and/or identified inventors. The AI system(s) 108 may, in some instances, also auto-fill metadata, such as project references and submission timestamps, ensuring compliance with internal invention disclosure requirements.

The method 500, at block B510, includes determining whether a public disclosure is planned for the invention. For instance, one or more of the AI system(s) 108, the management system 112, and/or the task escalation system 118 may determine whether the public disclosure is planned for the invention. In some examples, these components/systems may analyze internal communication records, project timelines, conference submission portals, and/or any other information to detect planned public disclosures, such as presentations, blog posts, research publications, etc. If a public disclosure is not planned, the method 500 may proceed to block B512, otherwise the method 500 may proceed to block B514 if a public disclosure is planned and/or is going to occur within a threshold period of time.

The method 500, at block B512, includes performing one or more first operations. For instance, if no public disclosure is planned, the management system 112 may continue monitoring relevant data sources for updates, allowing inventors or case managers to refine the submission over time. The management system 112 and/or the AI system(s) 108 may periodically check for changes in project documentation, inventor contributions, planned disclosures, or new developments that could impact the invention's technical details, ensuring that the submission remains current and complete before it enters the formal review process.

The method 500, at block B514, includes performing one or more second operations. For instance, if a public disclosure is imminent, the management system 112 may prioritize the submission by notifying relevant stakeholders, fast-tracking internal reviews, and/or automatically generating provisional patent filing documents. The management system 112 may, in some instances, update the invention submission document(s) with newly available data and ensure that legal teams are aware of the urgency of filing.

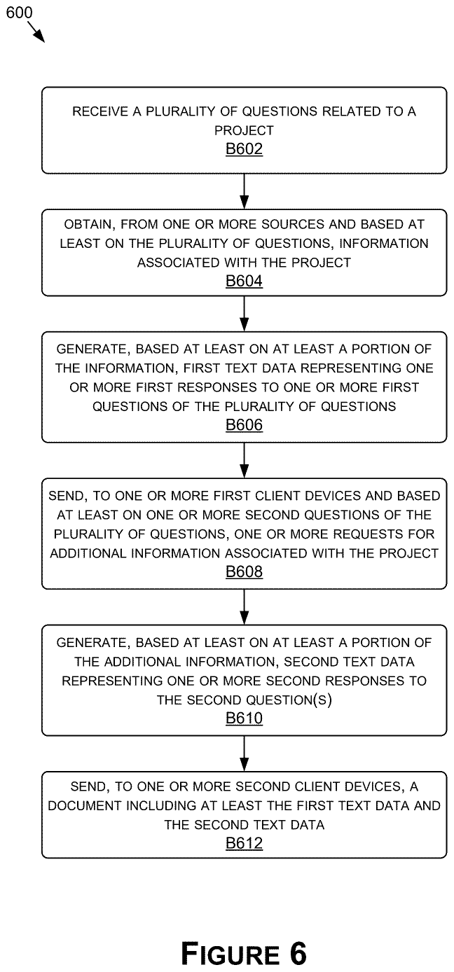

FIG. 6 is a flow diagram illustrating an example of a method 600 for generating a document using different portions of information obtained from various sources, in accordance with some embodiments of the present disclosure. The method 600, at block B602, includes receiving a plurality of questions related to a project. For instance, the document generation system 102 may receive the input data 120 indicating the plurality of questions related to the project.

The method 600, at block B604, includes obtaining, from one or more sources and based at least on the plurality of questions, information associated with the project. For instance, the information obtainer 106 may obtain the information 122 associated with the project form the data source(s) 110 based at least on the input data 120. In some instances, the input data 120 may indicate the data source(s) 110 to be used to obtain the information from, such as citations to technical documents, file locations of invention-related documents, etc.

The method 600, at block B606, includes generating, based at least on at least a portion of the information, first text data representing one or more first responses to one or more first questions of the plurality of questions. For instance, the AI system(s) 108 may generate the first text data representing the first response(s) to the first question(s). That is, the AI system(s) 108 may generate responses to a subset of the questions from the input data 120/invention disclosure form.

The method 600, at block B608, includes sending, to one or more first client devices and based at least on one or more second questions of the plurality of questions, one or more requests for additional information associated with the project. For instance, the AI system(s) 108 and/or the information obtainer 106 may send the request(s) for the additional information 128 to the client device(s) 114.

The method 600, at block B610, includes generating, based at least on at least a portion of the additional information, second text data representing one or more second responses to the one or more second questions. For example, the AI system(s) 108 may generate the second text data representing the second response(s) to the second question(s) based on at least the portion of the information 128 (and/or the information 122). That is, the AI system(s) 108 may generate responses to the questions it was unable to answer without obtaining the additional or supplemental information.

The method 600, at block B612, includes sending, to one or more second client devices, a document including at least the first text data and the second text data. For instance, the document generation system 102 may send the document(s) 126 including the first text data (e.g., first questions and/or first responses) and the second text data (e.g., second questions and/or second responses) to the client device(s) 116.

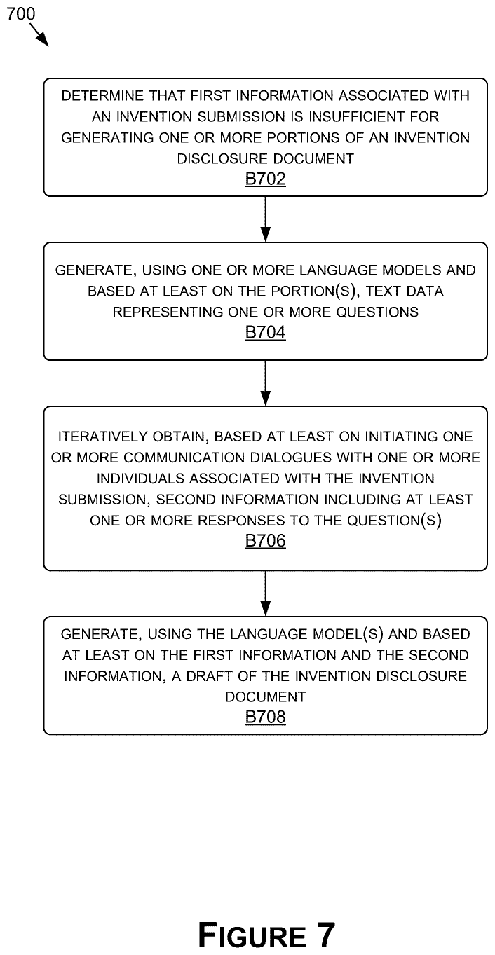

FIG. 7 is a flow diagram illustrating an example of a method 700 for obtaining additional information for generating an invention disclosure document, in accordance with some embodiments of the present disclosure. The method 700, at block B702, includes determining that first information associated with an invention submission is insufficient for generating one or more portions of an invention disclosure document. For instance, the AI system(s) 108 may determine that the information 122 is insufficient for generating the portion(s) of the document(s) 126. That is, the AI system(s) 108 may determine it is unable to generate responses to at least a subset of the questions (e.g., questions of the invention disclosure form).

The method 700, at block B704, includes generating, using one or more language models and based at least on the one or more portions, text data representing one or more questions. For instance, the AI system(s) 108 and/or the information obtainer 106 may generate the text data representing the question(s). The question(s) may be for obtaining additional information and/or supplemental information in order to generate the portion(s) of the invention disclosure document.

The method 700, at block B706, includes iteratively obtaining, based at least on initiating one or more communication dialogues with one or more individuals associated with the invention submission, second information including at least one or more responses to the one or more questions. For instance, the information obtainer 106 and/or the AI system(s) 108 may initiate the communication dialogue(s) with the client device(s) 114 and send the question(s) during the communication dialogue(s) so that the information 128 may be obtained. During the dialogue(s), the response(s) to the question(s) may be obtained, which may allow the AI system(s) 108 to generate the completed version of the invention disclosure document (e.g., document(s) 126).

The method 700, at block B708, includes generating, using the one or more language models and based at least on the first information and the second information, a draft of the invention disclosure document. For instance, the AI system(s) 108 may generate the document(s) 126 based at least on the first information (e.g., information 122) and the second information (e.g., information 128).

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model —or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features-such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated —e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e. g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e .g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining, from one or more sources and based at least on input data indicative of a plurality of questions related to a project, information associated with the project; generating, based at least on one or more multimodal models processing the input data and at least a portion of the information, first text data representing one or more first responses to one or more first questions of the plurality of questions; sending, to one or more first client devices and based at least on one or more second questions of the plurality of questions, one or more requests for additional information associated with the project; generating, based at least on the one or more multimodal models processing the input data and at least a portion of the additional information, second text data representing one or more second responses to the one or more second questions; and sending, to one or more second client devices, at least the first text data and the second text data.

B. The method of paragraph A, wherein obtaining the information associated with the project from the one or more sources comprises: obtaining data representative of at least one of one or more white papers, one or more meeting recordings, one or more meeting minutes, one or more emails, or one or more project management software archives; and generating, based at least on the one or more multimodal models processing the data, third text data representing the information.

C. The method of any one of paragraphs A-B, further comprising: initiating one or more chatbot interactions with the one or more first client devices to communicate with one or more individuals associated with the project; and wherein the sending of the one or more requests for the additional information is based at least on the initiating of the one or more chatbot interactions.

D. The method of any one of paragraphs A-C, further comprising: determining, based at least on the information, one or more identities of one or more individuals who contributed to the project, wherein at least one of the first text data or the second text data is indicative of the one or more identities.

E. The method of any one of paragraphs A-D, further comprising: receiving, from the one or more first client devices, an indication of a public disclosure associated with the project, wherein the sending of the first text data and the second text data to the one or more second client devices is based at least on the indication.

F. The method of any one of paragraphs A-E, further comprising: determining, based at least on the information, at least one of one or more locations or one or more citizenships associated with one or more individuals who contributed to the project, wherein at least one of the first text data or the second text data is indicative of the at least one of the one or more locations or the one or more citizenships.

G. The method of any one of paragraphs A-F, wherein the sending of the one or more requests for the additional information to the one or more first client devices comprises engaging in a communication dialogue with one or more individuals who are associated with the project to iteratively obtain the additional information.

H. The method of any one of paragraphs A-G, further comprising: obtaining, from one or more second sources, second information associated with one or more second projects; and determining, based at least on the one or more multimodal models comparing the information and the second information, one or more novel portions of the information with respect to at least the second information, wherein at least one of the first text data or the second text data is indicative of the one or more novel portions of the information.

I. A system comprising: one or more processors to: determine that first information associated with a proposal submission is insufficient for generating one or more portions of a proposal document; generate, using one or more language models and based at least on the one or more portions, text data representing one or more questions; iteratively obtain, based at least on initiating one or more communication dialogues with one or more individuals associated with the proposal submission, second information including at least one or more responses to the one or more questions; and generate, using the one or more language models and based at least on the first information and the second information, a draft of the proposal document.

J. The system of paragraph I, the one or more processors further to obtain, from one or more sources, the first information, wherein the one or more sources include at least one of: one or more digital recordings; one or more technical documents; one or more meeting transcripts; one or more email threads; or one or more design specifications.

K. The system of any one of paragraphs I-J, the one or more processors further to: determine, based at least on the first information, one or more identities of the one or more entities associated with the proposal submission, wherein the initiating of the one or more communication dialogues with the one or more entities is based at least on the determination of the one or more identities.

L. The system of any one of paragraphs I-K, the one or more processors further to: determine an announcement date associated with the proposal submission; determine that a period of time between a present date and the announcement date is less than a threshold; and based at least on the period of time being less than the threshold, send, to one or more devices of one or more reviewing entities, one or more requests to review at least one of the proposal submission or the draft of the proposal document.

M. The system of any one of paragraphs I-L, the one or more processors further to: determine an announcement date associated with the proposal submission; determine that a period of time between a present date and the announcement date is less than a threshold; and based at least on the period of time being less than the threshold, generate, using the one or more language models and based at least on the draft of the proposal document, second text data representing a draft of a proposal application.

N. The system of any one of paragraphs I-M, the one or more processors further to: determine, based at least on at least one of the first information or the second information, at least one of one or more locations or one or more citizenships associated with the one or more individuals, wherein the draft of the proposal document includes one or more fields including at least one of text data indicative of the one or more locations or text data indicative of the one or more citizenships.

O. The system of any one of paragraphs I-N, the one or more processors further to: compare, using one or more second language models, the proposal submission with one or more prior proposal submissions; and determine, based at least on the comparison, one or more novel aspects of the proposal submission, wherein the draft of the proposal document includes text data indicative of the one or more novel aspects.

P. The system of any one of paragraphs I-O, wherein the one or more language models include one or more multi-modal language models and at least one of the first information or the second information includes one or more of text data, image data, or audio data.

Q. The system of any one of paragraphs I-P, the one or more processors further to: generate, using one or more multimodal models and based at least on the first information and the second information, at least one of image data, audio data, or video data representing at least one of one or more images, one or more audio clips, or one or more videos corresponding to the one or more responses to the one or more questions, wherein the draft of the proposal document further includes at least one of the image data, the audio data, or the video data.

R. The system of any one of paragraphs I-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.

S. One or more processors comprising: processing circuitry to generate, using one or more language models, text data corresponding to a draft of a document based at least on information associated with a project, wherein the information is obtained, at least, by: analyzing one or more sources including one or more first portions of the information, the one or more sources corresponding to at least one of one or more technical documents, one or more meeting transcripts, one or more email threads, or one or more design specifications; and initiating one or more communication sessions with one or more individuals associated with the project to iteratively obtain one or more second portions of the information.

T. The one or more processors of paragraph S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.

1.-8. (canceled)

9. A system comprising one or more processors to:
determine that first information associated with a proposal submission is insufficient for generating one or more portions of a proposal document;
generate, using one or more language models and based at least on the one or more portions, text data representing one or more questions;
iteratively obtain, based at least on initiating one or more communication dialogues with one or more individuals associated with the proposal submission, second information including at least one or more responses to the one or more questions; and
generate, using the one or more language models and based at least on the first information and the second information, a draft of the proposal document.

10. The system of claim 9, the one or more processors further to obtain, from one or more sources, the first information, wherein the one or more sources include at least one of:
one or more digital recordings;
one or more technical documents;
one or more meeting transcripts;
one or more email threads; or
one or more design specifications.

11. The system of claim 9, the one or more processors further to:
determine, based at least on the first information, one or more identities of the one or more individuals associated with the proposal submission,
wherein the initiating of the one or more communication dialogues with the one or more individuals is based at least on the determination of the one or more identities.

12. The system of claim 9, the one or more processors further to:
determine an announcement date associated with the proposal submission;
determine that a period of time between a present date and the announcement date is less than a threshold; and
based at least on the period of time being less than the threshold, send, to one or more devices of one or more reviewing entities, one or more requests to review at least one of the proposal submission or the draft of the proposal document.

13. The system of claim 9, the one or more processors further to:
determine an announcement date associated with the proposal submission;
determine that a period of time between a present date and the announcement date is less than a threshold; and
based at least on the period of time being less than the threshold, generate, using the one or more language models and based at least on the draft of the proposal document, second text data representing a draft of a proposal application.

14. The system of claim 9, the one or more processors further to:
determine, based at least on at least one of the first information or the second information, at least one of one or more locations or one or more citizenships associated with the one or more individuals,
wherein the draft of the proposal document includes one or more fields including at least one of text data indicative of the one or more locations or text data indicative of the one or more citizenships.

15. The system of claim 9, the one or more processors further to:
compare, using one or more second language models, the proposal submission with one or more prior proposal submissions; and
determine, based at least on the comparison, one or more novel aspects of the proposal submission,
wherein the draft of the proposal document includes text data indicative of the one or more novel aspects.

16. The system of claim 9, wherein the one or more language models include one or more multi-modal language models and at least one of the first information or the second information includes one or more of text data, image data, or audio data.

17. The system of claim 9, the one or more processors further to:
generate, using one or more multimodal models and based at least on the first information and the second information, at least one of image data, audio data, or video data representing at least one of one or more images, one or more audio clips, or one or more videos corresponding to the one or more responses to the one or more questions,
wherein the draft of the proposal document further includes at least one of the image data, the audio data, or the video data. (Original) The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

19. (canceled)

20. (canceled)

21. A method comprising:
determining that first information associated with a proposal submission is insufficient for generating one or more portions of a proposal document;
generating, using one or more language models and based at least on the one or more portions, text data representing one or more questions;
iteratively obtaining, based at least on initiating one or more communication dialogues with one or more individuals associated with the proposal submission, second information including at least one or more responses to the one or more questions; and
generating, using the one or more language models and based at least on the first information and the second information, a draft of the proposal document.

22. The method of claim 21, further comprising obtaining, from one or more sources, the first information, wherein the one or more sources include at least one of:
one or more digital recordings;
one or more technical documents;
one or more meeting transcripts;
one or more email threads; or
one or more design specifications.

23. The method of claim 21, further comprising:
determining, based at least on the first information, one or more identities of the one or more individuals associated with the proposal submission,
wherein the initiating of the one or more communication dialogues with the one or more individuals is based at least on the determination of the one or more identities.

24. The method of claim 21, further comprising:
determining an announcement date associated with the proposal submission;
determining that a period of time between a present date and the announcement date is less than a threshold; and
based at least on the period of time being less than the threshold, sending, to one or more devices of one or more reviewing entities, one or more requests to review at least one of the proposal submission or the draft of the proposal document.

25. The method of claim 21, further comprising:
determining an announcement date associated with the proposal submission;
determining that a period of time between a present date and the announcement date is less than a threshold; and
based at least on the period of time being less than the threshold, generating, using the one or more language models and based at least on the draft of the proposal document, second text data representing a draft of a proposal application.

26. The method of claim 21, further comprising:
determining, based at least on at least one of the first information or the second information, at least one of one or more locations or one or more citizenships associated with the one or more individuals,
wherein the draft of the proposal document includes one or more fields including at least one of text data indicative of the one or more locations or text data indicative of the one or more citizenships.

27. The method of claim 21, further comprising:
comparing, using one or more second language models, the proposal submission with one or more prior proposal submissions; and
determining, based at least on the comparing, one or more novel aspects of the proposal submission,
wherein the draft of the proposal document includes text data indicative of the one or more novel aspects.

28. The method of claim 21, wherein the one or more language models include one or more multi-modal language models and at least one of the first information or the second information includes one or more of text data, image data, or audio data.

29. One or more processors comprising processing circuitry to:
determine that first information associated with a proposal submission is insufficient for generating one or more portions of a proposal document;
generate, using one or more language models and based at least on the one or more portions, text data representing one or more questions;
iteratively obtain, based at least on initiating one or more communication dialogues with one or more individuals associated with the proposal submission, second information including at least one or more responses to the one or more questions; and
generate, using the one or more language models and based at least on the first information and the second information, a draft of the proposal document.

30. The one or more processors of claim 29, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
